(19) United States
(12) Patent Application Publication
(10) Pub. No.: US 2005/0044464 A1
(43) Pub. Date: Feb. 24, 2005

(54) Method and radio station for data transmission in a radio communication system

(76) Inventors: Elena Costa, Garching (DE); Matthias Lott, Neuried (DE); Egon Schulz, Munchen (DE)

Correspondence Address: STAAS & HALSEY LLP, SUITE 700, 1201 NEW YORK AVENUE, N.W., WASHINGTON, DC, 20005, US

(21) Appl. No.: 10/491,114

(22) PCT Filed: Sep. 23, 2002
(86) PCT No.: PCT/DE02/03590

(30) Foreign Application Priority Data
Sep. 26, 2001 (DE) 101 47 487.3

(51) Int. Cl. G08C 25/00

(52) U.S. Cl. 714/746

(57) ABSTRACT

A data packet is sent from a first radio station to several second radio stations in a transmission channel, whereby the data packet is provided with a first error protection for a first transmission over the radio interface. Subsequently, the data packet is sent by the first radio station to the second radio station at least one further time, whereby the data packet is provided with a second error protection for further transmission over the radio interface, which has a higher redundancy than the first error protection.

The invention relates to a method and a radio station for data transmission in a radio communication system, in particular in a mobile radio system.

Radio communication systems are known in the form of mobile radio systems and wireless user access networks, also called wireless local area networks (WLANs). Mobile radio systems according to the prior art are, for example, the second-generation worldwide GSM system (Global System for Mobile Communications) and the future third-generation UMTS system (Universal Mobile Telecommunications System). These systems operate in frequency bands around approx. 1 and 2 GHz and use a TDMA (Time Division Multiple Access) or CDMA (Code Division Multiple Access) user separation method. Future WLAN systems are, for example, the Hiperlan/2 system standardized by ETSI (European Telecommunications Standards Institute) and the IEEE 802.11 system standardized by the IEEE. Both systems use an OFDM (Orthogonal Frequency Division Multiplex) transmission method with 64 subcarriers in the 5 GHz frequency band. These two WLAN systems are known for example from the book by B. Walke titled “Mobilfunknetze und ihre Protokolle” (“Mobile radio networks and their protocols”), B. G. Teubner, Stuttgart, 2000, Vol. 2, pages 370-432.

Both WLAN systems are based on a simple network structure, according to which elements called “access points” (APs) provide radio-based high-speed access at a typical data rate of 27 Mbit/s to various networks, such as, for example, UMTS core networks, ATM networks and IP-based networks. At the same time a potential mobility of the user stations, known as mobile terminals (MTs), is enabled in that handover methods, i.e. a connection transfer from one access point to a next access point, are supported.

A fundamental problem in radio systems of this kind arises during the transmission of distribution services, known as broadcast or multicast services, since data is often corrupted due to the different characteristics of the radio channels.

According to the prior art, combinations of a forward error correction (FEC) mechanism and ARQ (Automatic Repeat Request) methods are mostly employed in radio communication systems for what are termed unicast connections, i.e. point-to-point connections between two radio stations, in order to guarantee a required quality of service (QoS) or residual error probability during the transmission. If FEC methods fail in poor radio channel conditions, such as fading for example, or due to strong interference factors, data either received incorrectly or not received at all by the receiver can be restored with a high degree of probability by a retransmission according to the ARQ method.

With the ARQ method, correctly received data packets are acknowledged by means of positive acknowledgements (ACK=Acknowledgement), and in the case of incorrectly received data packets a request for retransmission is sent by the receiver by means of a negative acknowledgement (NAK=Negative Acknowledgement) in a signaling packet data unit (S-PDU).

According to the prior art, exclusive use is made of FEC methods to assure reliable data transmission for distribution services or also general signaling systems. ARQ methods are not used to that effect since the transmission capacities required for this on the return channels would be too great, and as the number of users increased the probability of an error-corrupted data transmission would increase in any case. To supplement a strong FEC method, a method known as repetition mode is used for example in the Hiperlan/2 system described. With this mode, the same data is transmitted a number of times in succession without an acknowledgement of receipt being transmitted on the part of the receiving radio stations. However, even a multiple transmission of data packets of this kind still does not guarantee error-free reception.

The object of the invention is therefore to specify a method which enables reliable transmission of data of a distribution service. This object is achieved by the features of the independent claims. Advantageous developments of the invention can be derived from the dependent claims.

According to the invention, a data packet is provided with a first error protection means for a first transmission over the radio interface of the radio communication system. In the subsequent at least one further transmission the data packet is provided with a second error protection means which has an increased redundancy compared with the first error protection means.

Advantageously, an increased probability of the correct reception of the data packet at the location of the second radio stations is ensured owing to the increased redundancy for the further transmission, as a result of which its use for a point-to-multipoint transmission appears advantageous. Furthermore the energy consumption of the second radio station, embodied for example as a mobile radio station, can advantageously be reduced, since following a successful reception of the first transmission of the data packet subsequent transmissions no longer have to be received and evaluated.

According to a development of the invention, the redundancy is increased in accordance with an ARQ method with incremental redundancy. In combination with the development based on this feature, according to which the reception of the data packet is not acknowledged by the second radio stations, the known Type 2 ARQ method, for example, is adapted in an optimal manner to the conditions of the data transmission in distribution services. The implementation corresponds in this case to an efficient ARQ method without use of a return channel. At the same time data packets not received or received corrupted are not requested explicitly by means of a negative acknowledgement, but instead negative acknowledgements are assumed on the transmitter side without said negative acknowledgements actually having been received. Thus, as a result of the ARQ method based on an incremental redundancy the same data packets are not transmitted a number of times, but different data packets are transmitted, whereby the information contained therein can already be extracted from the first data packet. If multiple data packets are used for decoding the information when transmission errors are present, then the probability of a correct decoding is advantageously increased. With the exemplary Type 2 ARQ method, virtually arbitrarily small coding rates can be advantageously defined and consequently more redundancy added to a data packet than would be possible with the known FEC methods.

According to a further development of the invention, the first and/or second error protection means are chosen as a function of characteristics of the radio interface. In this way more or less redundancy is added to the data packets, for example depending on the current radio channel characteristics, and if necessary more or fewer further data packets are transmitted with incremental redundancy. With good transmission characteristics, for example, the number of further data packets is reduced, as a result of which the transmission capacity in the transmission channel is advantageously increased. The respective difference or deviation between the coding rates can also be set as a function of the characteristics of the radio interface. The first radio station or a higher-ranking entity of the radio communication system can determine the characteristics for example from known signaling schemes of the second radio stations via the radio channel characteristics, request them from the second radio stations using a special signaling scheme or derive them from received signals of the second radio stations.

According to a further development of the invention, the further transmission of the data packet with the second error protection means is executed only after a specific time interval. As a result, compared with the repetition mode already described, the data packets are transmitted not in immediate succession, but in time-staggered fashion so that, for example, the fading effects of the radio channel can advantageously be exploited. If, for example, when an FEC method is used, a retransmission of the data packet during a fading period would not enable a correct decoding to be performed in certain circumstances, with the use of an incremental redundancy method a successful decoding can be enabled by transmission of a further, incrementally coded data packet at a time at which the radio channel exhibits more favorable characteristics.

The method according to the invention is used particularly advantageously in radio communication systems based on a TDD (Time Division Duplex) method. TDD means that the transmission takes place both in the uplink and in the downlink direction in a common transmission frame. Examples of systems of this kind are the Hiperlan/2 and IEEE 802.11 systems cited at the beginning.

Further features and advantages of the invention are derived from the claims and the following description of an exemplary embodiment with reference to the drawing, in which:

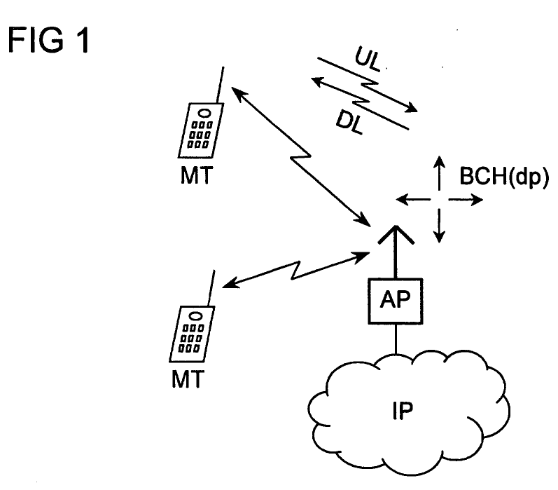

FIG. 1 shows a structure of a radio communication system in which the method according to the invention is performed.

FIG. 1 shows a section of a radio communication system of the type implemented, for example, in the Hiperlan/2 system. The structure of the components relevant to the method according to the invention can be transferred in identical fashion to other radio communication systems. A base station AP (Access Point) is connected via, for example, an Internet protocol-based transmission network IP to further network components and provides what is called an access point to this network for user stations MT (Mobile Terminal) located in the radio coverage area of the base station AP. The transmission over the radio interface takes place here in the downlink direction DL from the base station AP to the user stations MT and also in the uplink direction UL from the user stations MT to the base station AP, and because of the variant characteristics of the radio interface is exposed to fault conditions due to fading, shadowing, interference, etc.

According to FIG. 1, the base station sends data packets dp to the receiving user stations MT in a distribution channel BCH (Broadcast Channel). In this case said data packets can contain for example signaling and/or user data of services. According to the invention, the base station AP sends the data packets dp in the distribution channel BCH a number of times in each case, in the process strengthening the error protection of the respective data packet dp by increasing the redundancy for each further transmission. The correct reception of the data packets dp is not acknowledged by the receiving user stations MT. Instead, the number of data packets dp sent in addition and the redundancy increment are adjusted by the base station AP to match the current characteristics of the transmission channel.

1-11. Cancel

12. A method for data transmission in a radio communication system, comprising:
sending a data packet by a first radio station to a plurality of second radio stations via a transmission channel in a first transmission over a radio interface with a first error protection mechanism; and
subsequently sending the data packet by the first radio station at least one additional time to the second radio stations over the radio interface with a second error protection mechanism which has an increased redundancy compared with the first error protection mechanism.

13. The method according to claim 12, wherein the data packet includes at least one of user data and signaling information.

14. The method according to claim 13, wherein the increased redundancy when the data packet is subsequently sent at least one additional time is effected according to an Automatic Repeat Request method with incremental redundancy.

15. The method according to claim 14, further comprising not acknowledging each correct reception of the data packet by the second radio stations.

16. The method according to claim 15, further comprising at least one of the first and second error protection mechanisms as a function of characteristics of the radio interface.

17. The method according to claim 16, further comprising choosing a number of additional times the data packet is subsequently sent as a function of characteristics of the radio interface.

18. The method according to claim 17, wherein said subsequently sending of the data packet with the second error protection mechanism is performed by the first radio station after a specific time interval has elapsed.

19. The method according to claim 18, wherein the data transmission takes place in the radio communication system in accordance with a wireless local area network standard.

20. The method according to claim 19, wherein one of Hiperlan/2 and IEEE 802.11 is used as the wireless local area network standard.

21. A radio communication system having a plurality of radio stations, comprising:
a radio station sending a data packet to other radio stations via a transmission channel in a first transmission over a radio interface with a first error protection mechanism and subsequently sending the data packet at least one additional time to the other radio stations over the radio interface with a second error protection mechanism which has an increased redundancy compared with the first error protection mechanism.

22. The radio communication system according to claim 21, wherein said radio station is a base station.
